(19) United States
(12) Patent Application Publication
(10) Pub. No.: US 2016/0185894 A1
(43) Pub. Date: Jun. 30, 2016

(54) Polyfunctional Polyglycerine Initiated Polyether Polyols and High Resilience Polyurethane Slabstock Therefrom

(71) Applicant: Dow Global Technologies LLC, Midland, MI (US)

(72) Inventors: Francois M. Casati, Pfaeffikon (CH); Esther E. Quintanilla, Horgen (CH); Hanno R. Van Der Wal, Hoek (NL); Timothy A. Morley, Freienbach (CH); Peter Mullaert, Terneuzen (NL)

(21) Appl. No.: 15/060,402

(22) Filed: Mar. 3, 2016

Related U.S. Application Data
(63) Continuation of application No. 13/578,658, filed on Sep. 20, 2012.
(60) Provisional application No. 61/308,268, filed on Feb. 25, 2010.

(51) Int. Cl. C08G 18/48; C08G 65/48

(52) U.S. Cl. CPC C08G 18/4866; C08G 65/48; C08G 2101/0025

(57) ABSTRACT

A polyglycerine initiated polyether polyol exhibiting a final functionality less than the nominal functionalities of the polyol initiator wherein the initiator is a polyglycerine formed by the polymerization of glycerin having an HEW less than about 35 and exhibiting a nominal functionality between 2 and 16 is provided. Also provided is a process for producing a polyfunctional polyurethane by the reaction of a mixture containing a polyol based on polyglycerine initiator wherein between 5 wt % and 100 wt % of the total initiator is polyglycerine having a nominal functionality between 2 and 16, at least one organic isocyanate, an amine and/or a metal salt catalyst, and optionally a blowing agent. Also provided is a flexible polyurethane foam comprising a reaction product of a polyglycerine or formed by the glycidol polymerization of glycerin, at least one organic isocyanate, and an amine catalyst.

### BACKGROUND OF THE INVENTION

This invention relates to polyglycerine initiated polyether polyols with adjustable average functionalities, and more particularly to production of high quality, flexible polyurethane foams produced utilizing such polyether polyols.

The rapid growth of the plant-derived oleochemicals industry in Asia and the growing biodiesel production worldwide have resulted in an abundant supply of glycerin, resulting in substantial lowering of glycerin market price. One possible application of glycerin is the formation of polyglycerine for use as a starter or initiator for polyols, including for example, flexible polyurethane foams. Use of polyglycerine to replace more expensive initiators in polyurethane foam production could lead to cost savings in the production of such foams and improved foam properties.

The properties of polyurethane foams depend strongly upon the foaming and polymerizing efficiencies of the polyol which is in turn governed by the structural properties of the initiator, its functionality and extent of branching, by its equivalent weight (EW), molecular weight distribution (MWD), ratio of ethylene oxide to propylene oxide (EO/PO), primary OH percentage, by-products formed and molar mass. Flexible polyols have functionality, called final or real functionality, which is always lower than the starter or nominal functionality. This is due to side reactions (i.e., monol and diol formations) which occur during the long alkoxylation time needed to get the desired high equivalent weights (e.g., higher than 1000) needed for a flexible foam versus rigid polyols having shorter chains (i.e., equivalent weights).

It is also known that the type of catalyst used for the alkoxylation impacts the degree of side reactions. For instance, KOH gives more side reactions or higher unsaturation (above 0.02 meq/g) than DMC (Double Metal Catalyst) which is used to manufacture polyols with low unsaturation (below 0.02 meq/g). Hence, KOH catalyzed polyols have lower final functionality than DMC catalyzed polyols made from the same initiator having identical nominal functionality.

It is also known that HR (High Resiliency) foams are made with high equivalent weight polyols (higher than 1,500) and that the higher the EW the more pronounced are the side reactions leading to high unsaturations which decrease final functionality.

In general, higher functionality polyols (i.e., having a nominal functionality higher than 3) results in harder foams and low TTE (Tear, Tensile and Elongation) properties. Polyglycerine (polyether) is a high functionality initiator because its functionality is higher than 3, thus giving a high functionality polyol. Usually, when a high functionality polyol is used to produce flexible foams it is combined with a lower functionality polyol. This can be done by blending polyols or, more preferably, by co-initiation of a high functionality (f1) initiator and a low functionality (f2) initiator, for instance by combining sucrose (f1=8) and water (f2=2), or sorbitol (f1=6) and glycerol (f2=3), in order to achieve a nominal functionality between 2 and 4. Thus, to take advantage of the cost savings possibly afforded by use of glycerin to form polyglycerine as an initiator for flexible polyurethane foam production, it would be desirable to produce polyglycerine initiators with adjustable functionality and to produce high equivalent weight polyether polyols from such adjustable functionality polyglycerine in order to optimize foam properties, especially foam TTEs.

U.S. Pat. No. 6,710,096 discloses the adjustment of final polyol functionality by use of polyfunctional initiators based on starch hydrolysate and optionally a second initiator thereby not taking advantage of the potential cost savings through use of polyglycerine as the initiator. Those known processes using polyglycerine based polyols as initiators do not provide adjustable functionality but rather depend upon: (1) limiting the level of polyols used in the formulation (i.e., limited to <50% polyol) (see JP 2005232382; (2) use of the polyglycerine solely as a crosslinker in the formulation (see JP 4010174); or (3) used as hydrophilic polyols for specialty foam applications (JP 44011671).

It is known that the structure of the initiator influences the molecular weight distribution of the final polyol. For instance TMP (trimethylolpropane) having three primary hydroxyls usually gives a more regular distribution of equivalent weights than glycerin which contains a secondary hydroxyl moiety. One characteristic of the polyglycerin chemistry is to allow adjustment of the initiator in terms of primary and secondary hydroxyls, as well as degree of branching, thus to optimize the MWD of the final polyol in order to achieve improved foam properties.

It is also known that polyols having broad molecular weight distributions are undesirable due to their relatively high viscosities, which can aversely impact polyurethane formulations. In addition, it is known that polyols with narrow molecular weight distributions generally result in polyurethanes with better physical properties.

It is further known to produce high functionality polyols with narrow equivalent weight distributions for rigid foams manufactured by using polyglycerine initiators as described in DE 1814923, DE 1109649 and US 20100029799. Rigid foams have closed cells for thermal insulation application and no measurable TTE properties. Such rigid polyols have high viscosities.

It has been surprisingly found that polyglycerines of the present invention provide, when alkoxylated, high molecular weight polyols having relatively low viscosities and when used to produce flexible foams bring improved physical properties, especially improved TTE compared to known co-initiation technology.

Another aspect of the invention provides slabstock flexible polyurethane foams which can be handled and transported without physical damages by foam tearing.

Another aspect of using polyglycerol is that it is a liquid at ambient conditions while conventional high functionality initiators, such as sorbitol and sucrose, are solid making them more difficult to handle in polyol manufacturing plants.

### SUMMARY OF THE INVENTION

Embodiments of the invention provide polyfunctional polyglycerine initiated polyether polyols. Yet other embodiments of the invention provide flexible polyurethane foams produced using such polyfunctional polyglycerine initiators. Some embodiments of the invention provide flexible polyurethane foams exhibiting improved physical properties (i.e., TTE) as well as improved performance characteristics.

The improvements further provided by various embodiments of the invention include optimization of foam processing i.e. foam manufacturing by adjusting polyol average functionality and equivalent weight. In addition, embodiments of the invention provide processes for fine tuning flexible foam properties by providing a polyol with sequential multiple functionalities. That is, some aspects of the invention provide a process for designing, by adjustment of experimental parameters and feed materials, a polyol initiator based on polyglycerine which is used to further design a final polyol by adjustment of alkoxylation conditions. In other aspects of the invention, the final polyol is utilized to produce flexible polyurethane foams having superior physical properties while exhibiting good processability.

In certain embodiments of the invention, the polyols exhibit a maximum degree of polymerization of the polyglycerine in the polyglycerine based polyol of equal to or less than 30 while in certain other embodiments the degree of polymerization is no greater than 15.

In certain particular embodiments, a polyglycerine initiated polyether polyol exhibiting a final functionality less than the nominal functionalities of the polyol initiator wherein the initiator is a polyglycerine formed by the polymerization of glycerin (HEW>35) and exhibiting a nominal functionality between 2 and 16 is provided. In some instances of the invention, the polyol initiator comprises at least three functionalities. In yet other aspects of the invention, the polyether polyol has a final functionality between 1.5 and 6, an equivalent weight between 800 and 4,000, and/or an unsaturation between 0.02 meq/g and 1.0 meq/g.

A process for producing a polyurethane by the reaction of a mixture comprising: a polyol composition wherein between 5wt % and 100 wt % of the total polyol composition is a polyglycerine initiated polyol having a nominal functionality between 2 and 16; and at least one organic isocyanate; an amine catalyst; optionally in the presence of a blowing agent is provided in particular embodiments of the invention. In some aspects, the polyol initiator is polyglycerine formed by the glycidol polymerization of glycerine which occurs at temperatures less than 130° C. or polycondensation of glycerine at temperatures higher than 210° C.

In another aspect of the invention, a flexible polyurethane foam comprising a polyol initiated by the reaction product of a polyglycerine formed by the glycidol polymerization of glycerin, at least one organic isocyanate, and an amine catalyst is provided.

### DESCRIPTION OF THE PREFERRED EMBODIMENTS

Embodiments of the invention provide polyether polyols having an average polyol functionality (“final functionality” or “average functionality”) that is adjustable by either changing the initiator average functionality (“nominal functionality”) or by introducing side reactions during alkoxylation or both. By adjusting the polyol final functionality it is possible to optimize either foaming processability or flexible foam physical characteristics or both.

Embodiments of the present invention are based on controlled polymerization of glycerol thereby producing polyglycerine which is subsequently used as a starter. The inventive process provides polyols with sequential, multiple functionalities. Additionally a range of different equivalent weights is possible due to different reactivities of these initiators with either ethylene oxide, propylene oxide, butylene oxide or other known alkoxylating agents.

In a preferred embodiment of the invention, polyfunctional polyglycerine initiated polyols are produced using polyglycerine produced by the polymerization of glycerin. The glycerin may be of any source and is used to produce polyglycerine with at least 5% and up to 100% of glycerin incorporated into the polyglycerine.

The polyglycerine composition is adjusted during polycondensation by controlling the amount of water released by the reaction, and stopping the reaction when the desired amount is obtained. Free glycerine can be left in the polyglycerine initiator because the polyol is used for flexible foams. Conditions for such a polycondensation are similar to the ones described in US 20090082483, the disclosure of which is incorporated herein by reference.

In another aspect of the invention, glycidol is reacted with glycerin in the presence of an alkaline catalyst, such as KOH, at low temperatures to optimize the formation of the linear product. The nominal functionality of this starter is at least 2 and up to 16. The molar ratio of glycerine to glycidol may range from 1:1 to 1:5.

In alternative embodiments of the invention, the glycerine is reacted with other polyols, such as pentaerythritol or trimethylol propane (TMP), or alternatively amines, such as EDA. Yet other co-reactants may include epoxides, acids, or esters.

In yet other embodiments, the polyglycerine can be reacted with other polyols such as pentaerythritol or TMP, or amines such as EDA. In yet other embodiments of the invention, the polyglycerine may be co-reacted with other functional compounds, such as epoxides, acids or esters.

In yet another embodiment, the polyglycerine initiator is used as a co-initiator with either a polyalcohol, an aminoalcohol or an amine bearing secondary or primary amine functions, or blends thereof, to manufacture a flexible polyol.

In yet another embodiment, the polyglycerine initiator is made by reacting glycerine and eventually glycidol with an aminoalcohol bearing a tertiary amine moiety able to provide autocatalytic functions for the polyurethane reactions to the polyol, once this polyglycerine-aminoalcohol initiator is alkoxylated. One example of an autocatalytic aminoalcohol useful in certain embodiments of the invention is N-methyl-diethanol amine.

The polyglycerines produced in accordance with embodiments of the invention comprise a minimum of three functionalities. The polyol initiated with polyglycerines has final functionality of between 1.5 and 6, with the exact final functionality tailored to meet the performance requirements of the intended polyether polyol. The inventive polyols have an unsaturation from 0.02 to 1.0 meq/g. The polyol equivalent weight may range from 800 to 4,000.

Polyols may be reacted with isocyanates to form polyurethanes. The glycerin/glycidol polyglycerine based polyols useful in the invention may be used to produce polyurethane foams, comprising between 2% and 100% of the polyol component. Other polyols that can be combined with the polyglycerine polyol are polyether, polyesters and co-polymer polyols, i.e. polyols with in situ polymerization of styrene and acrylonitrile, or PIPA (Polyaddition polyol) or PHD (DolyHarnstoff) polyols.

Any isocyanate can be used (e.g., TDI (toluene diisocyanate), MDI, PMDI, apliphatic isocyanate, etc.), prepolymers, and blends thereof to produce polyurethanes based on polyether polyols using the glycerin/glycidol polyglycerine of the present invention. Resultant foam density may vary between 5 kg/m3 and 500 kg/m3.

Embodiments of the invention provide polyglycerine initiated polyols with adjustable average functionalities and fine tuning of multiple functionalities. The polyols produced in embodiments of the invention may be used in any polyurethane flexible foam application and further provide optimization of foam processing i.e. foam manufacturing by way of adjusting polyol average functionality and equivalent weights. In preferred embodiments of the invention, the polyglycerines exhibit multiple functionality, allowing for the “fine tuning” of flexible foam properties.

The isocyanates which may be used with the polyfunctional polyglycerine initiated polyols of the present invention include aliphatic, cycloaliphatic, arylaliphatic and aromatic isocyanates. Aromatic isocyanates, especially aromatic polyisocyanates are preferred. Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

Examples of suitable aromatic isocyanates include the 4,4′-, 2,4′ and 2,2′-isomers of diphenylmethane diisocyanate (MDI), blends thereof and polymeric and monomeric MDI blends toluene-2,4- and 2,6-diisocyanates (TDI), biuret modified TDI's, polymerized isocyanates, m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

For the production of flexible foams, the preferred polyisocyanates are the toluene-2,4- and 2,6-diisocyanates or MDI isomer blends or combinations of TDI/MDI or TDI/polymeric MDI or prepolymers made therefrom.

For flexible foam, the organic polyisocyanates and the isocyanate reactive compounds are reacted in such amounts that the isocyanate index, defined as the number or equivalents of NCO groups divided by the total number of isocyanate reactive hydrogen atom equivalents multiplied by 100, ranges from 50 to 120 and preferably between 80 and 115.

The polyurethane compositions of the present invention may further comprise other components that are conventionally employed in polymerizable systems. These components include, but are not limited to catalysts, solvents, plasticizers, pigments, colorants, dyes, surfactants, thickeners, heat stabilizers, leveling agents, anti-cratering agents, fillers, sedimentation inhibitors, ultraviolet-light absorbers, and the like. Additives such as promoters, heat stabilizers, ultraviolet-light absorbers, etc. may be intimately dispersed in the reaction mixture and apparently thereby become an integral part of the polymer. Preferred antioxidants are sterically hindered phenolic compounds. Stabilizers such as organic phosphites are also useful. Preferred UV inhibitors are benzotriazole compounds.

Chemistries and processes to produce flexible polyurethane foams by free rise or molding, continuous or discontinuous, are described in “Polyurethane Handbook” by G. Oetel et al, Hanser publisher, 1994.

### Test Methods Used

a. Test methods for polyol properties

MALDI-ToF/MS and HPLC-RI were used to determine the amounts and identities of by-products and the molar mass of the examples and comparative examples. HPLC-RI was used to determine the average functionality, equivalent weight (EW), and the mole percentage of hydroxyl groups (“% —OH”). 13C-NMR was utilized to determine the amount of branched end groups and primary OH groups.

High Performance Liquid Chromatography with Refractive Index Detection (HPLC-RI) was performed as follows:

Samples were prepared by dissolution of about 100 mg of the polyglycerine samples in 5 mL of 75/25 acetonitrile/water solution, for all examples and comparative examples except comparative example 2, which was dissolved in a 80/20 mixture of acetonitrile/water mixture.

The mobile phase solution was a 75/25 ACN/H2O mixture. The components were separated using isocratic elution with refractive index detection. A Varian Microsorb-MV 100-3 Amino (100×4.6 mm 3 μm) column and an Agilant 1200 G1362A RI detector with an RI temperature of 35° C. and an RI peak width of >0.2 min. were used.

The mole percentage of hydroxyl groups % —OH data were calculated from the HPLC-RI data according to the following equation (1):

$$\% - OH = \frac{Σ \% - {OH}_{i} * {mol}_{i}}{Σ {mol}_{i}} \\ where , \\ \% - {OH}_{i} = ( \frac{{M}_{OH} * {F}_{i}}{{M}_{wi}} ) * 100 \\ where {M}_{OH} = 17 g \text{/} mol . \qquad ( 1 )$$

where the subscript “i” refers to component i.

The molar mass of the samples was determined from the HPLC chromatograms and from the MALDI-ToF/MS spectra. The Mw values determined by HPLC-RI were calculated according to equation (2) below:

$$M \text{?} = \frac{Σ {M}_{{w}_{i}} * area - {\%}_{i}}{Σ area - {\%}_{i}} \\ \text{?} \text{indicates text missing or illegible when filed} \qquad ( 2 )$$

From the area % of each peak. The Mn values were calculated by dividing the total weight of the sample by the total number of molecules and it was assumed that the RI detector response of each peak (in area %) equals the wt %.

Samples for MALDI-ToF/MS analysis were prepared by dissolving the polyglycerine samples in THF, 2 mg/ml. 20 mg dithranol/ml THF was used as the matrix and 1 mg Nal/mL THF was used as the salt. The three solutions were then mixed in the ratio 1:2:1 prior to injection.

Samples for 13C-NMR were prepared by dissolving 2 g of the polyglycerine in 2 ml DMSO-d6 (containing 0.025M Cr (III) acetylacetonate) in a 10 mm NMR tube. Inverse gate 13C acquisitions were made to obtain semi-quantitative spectra.

Equivalent weight was calculated as Mn/Fi=EW. The EW differs when the Mn from HPLC-RI or MALDI-ToF/MS are used in the calculation. In both cases, Fi determined by the HPLC-RI method were used for calculating EW.

b. Test methods for foam properties

Density, resiliency, airflow and tear strength are measured according to ASTM 3574-05. CFD hardness and percent hysteresis are measured according to Peugeot D41.1003.386. Wet compression set with skin is measured in accordance with Renault RP 1637-81. Tensile strength and elongation at break are measured according to ISO 1798.

### Polyglycerine Examples and Comparative Examples

Polyglycerine Examples PG-1, PG-2, PG-3 and PG-4 were produced in the presence of KOH (0.5 mol %) by the reaction of glycerin, as the initiator, and glycidol by glycidol polymerization in the ratios shown in Table 1.

TABLE 1

| | | Theoretical |
|---|---|---|
| | | functionality, |
| Initiator Compounds | Description | Fₜₕ |
| 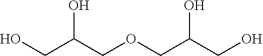 [SMILES: OCC(O)COCC(O)CO] | PG-1: 1 mole glycerin + 1 mole glycidol | 4 |
| 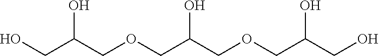 [SMILES: OCC(O)COCC(O)COCC(O)CO] | PG-2: 1 mole glycerin + 2 mole glycidol | 5 |
| 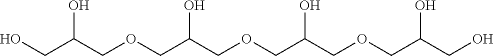 [SMILES: OCC(O)COCC(O)COCC(O)COCC(O)CO] | PG-3: 1 mole glycerin + 3 mole glycidol | 6 |
| 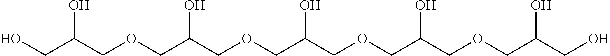 [SMILES: OCC(O)COCC(O)COCC(O)COCC(O)COCC(O)CO] | PG-4: 1 mole glycerin + 4 mole glycidol | 7 |

The reactor temperature was maintained at about 100° C.

Polyglycerin Example PG-5, which is a tetraglycerin average oligomer composition, was prepared by the condensation-of glycerin in the presence of 0.3% Na2CO3 at 245° C.

Table 2 below summarizes the HPLC-RI data for example PG-2, including the degree of polymerization, theoretical functionality (F), molecular weight, wt % for the component peaks and the average functionality (i.e., 4.9) for the PG-2 example.

TABLE 2

| | | | | | Area-% = | | | |
|---|---|---|---|---|---|---|---|---|
| Peak | DP | F | Mw | Area counts | wt-% | mol | F * mol | F |
| glycerin | 1 | 3 | 92.1 | 1,172,889 | 8.0 | 0.087 | 0.261 | |
| 2-gly | 2 | 4 | 166.2 | 2,878,916 | 19.7 | 0.119 | 0.474 | |
| 3-gly | 3 | 5 | 240.3 | 3,316,109 | 22.7 | 0.094 | 0.472 | |
| 4-gly | 4 | 6 | 314.3 | 2,825,466 | 19.3 | 0.061 | 0.369 | |
| 5-gly | 5 | 7 | 388.4 | 1,960,303 | 13.4 | 0.035 | 0.242 | |
| 6-gly | 6 | 8 | 462.5 | 1,201,342 | 8.2 | 0.018 | 0.142 | |
| 7-gly | 7 | 9 | 536.6 | 661,246 | 4.5 | 0.008 | 0.076 | |
| 8-gly | 8 | 10 | 610.7 | 330,718 | 2.3 | 0.004 | 0.037 | |
| 9-gly | 9 | 11 | 684.7 | 160,305 | 1.1 | 0.002 | 0.018 | |
| 10-gly | 10 | 12 | 758.8 | 76,100 | 0.5 | 0.001 | 0.008 | |
| 11-gly | 11 | 13 | 832.9 | 36,048 | 0.2 | 0.000 | 0.004 | |
| | | | | 14,619,443 | 100 | 0.429 | 2.103 | 4.9 |

Table 3 below summarizes the HPLC-RI data for example PG-4, including the degree of polymerization, theoretical functionality (F), molecular weight, wt % for the component peaks of the PG-4 example. The average functionality of the PG-4 example was 6.5.

TABLE 3

| | | | | Area | | | |
|---|---|---|---|---|---|---|---|
| PG-4-A | DP | F | Mw | counts | area-% = wt-% | mol | mol-% |
| Glycerin | 1 | 3 | 92.1 | 296260 | 2.3 | 0.025 | 8.9 |
| 2-gly | 2 | 4 | 166.2 | 889857 | 7.0 | 0.042 | 14.8 |
| 3-gly | 3 | 5 | 240.3 | 1447039 | 11.4 | 0.047 | 16.6 |
| 4-gly | 4 | 6 | 314.3 | 1829291 | 14.4 | 0.046 | 16.1 |
| 5-gly | 5 | 7 | 388.4 | 1885802 | 14.9 | 0.038 | 13.4 |
| 6-gly | 6 | 8 | 462.5 | 1737219 | 13.7 | 0.030 | 10.4 |
| 7-gly | 7 | 9 | 536.6 | 1462505 | 11.5 | 0.021 | 7.5 |
| 8-gly | 8 | 10 | 610.7 | 1130683 | 8.9 | 0.015 | 5.1 |
| 9-gly | 9 | 11 | 684.7 | 802502 | 6.3 | 0.009 | 3.2 |
| 10-gly | 10 | 12 | 758.8 | 532156 | 4.2 | 0.006 | 1.9 |
| 11-gly | 11 | 13 | 832.9 | 351929 | 2.8 | 0.003 | 1.2 |
| 12-gly | 12 | 14 | 907.0 | 223238 | 1.8 | 0.002 | 0.7 |
| 13-gly | 13 | 15 | 981.1 | 108947 | 0.9 | 0.001 | 0.3 |
| Σ | | | | 12697430 | 100 | 0.286 | 100 |

Table 4 below summarizes the HPLC-RI data for comparative example PG-5, including the degree of polymerization, theoretical functionality (F), molecular weight, wt % for the component peaks and the average functionality (i.e., 4.7) for the PG-5 example.

TABLE 4

| | | | | Area | area-% = | | |
|---|---|---|---|---|---|---|---|
| PG-5 | DP | F | Mw | counts | wt-% | mol | mol-% |
| Glycerin | 1 | 3 | 92.1 | 1836058 | 13.2 | 0.144 | 30.5 |
| 2-gly | 2 | 4 | 166.2 | 3228250 | 23.3 | 0.140 | 29.7 |
| 3-gly | 3 | 5 | 240.3 | 2723074 | 19.6 | 0.082 | 17.3 |
| 4-gly | 4 | 6 | 314.3 | 1983123 | 14.3 | 0.045 | 9.7 |
| 5-gly | 5 | 7 | 388.4 | 1344827 | 9.7 | 0.025 | 5.3 |
| 6-gly | 6 | 8 | 462.5 | 919367 | 6.6 | 0.014 | 3.0 |
| 7-gly | 7 | 9 | 536.6 | 622256 | 4.5 | 0.008 | 1.8 |
| 8-gly | 8 | 10 | 610.7 | 437185 | 3.2 | 0.005 | 1.1 |
| 9-gly | 9 | 11 | 684.7 | 296409 | 2.1 | 0.003 | 0.7 |
| 10-gly | 10 | 12 | 758.8 | 196510 | 1.4 | 0.002 | 0.4 |
| 11-gly | 11 | 13 | 832.9 | 132835 | 1.0 | 0.001 | 0.2 |
| 12-gly | 12 | 14 | 907.0 | 76982 | 0.6 | 0.001 | 0.1 |
| 13-gly | 13 | 15 | 981.1 | 47991 | 0.3 | 0.000 | 0.1 |
| 14-gly | 14 | 16 | 1055.1 | 20982 | 0.2 | 0.000 | 0.0 |
| Σ | | | | 138,658,49 | 100.0 | 0.471 | 100 |

Table 5 below summarizes the HPLC-RI, MALDI-ToF, and NMR data for low mol weight, LMW- cyclic compounds, free monomer and branching of the PG-1, PG-2, PG-3, PG-4 and PG-5.

TABLE 5

| | HPLC-RI | | NMR | | |
|---|---|---|---|---|---|
| | LMW- Cyclic | Free | Branched | Primary | |
| | compounds | glycerin | end groups | OH | MALDI |
| Sample | (wt %) | (wt %) | (mol %) | (mol %) | Distribution |
| PG-1 | 0.9 | 23.3 | — | — | 1 |
| PG-2 | 1.5 | 8 | 24 | 45 | 1 |
| PG-3 | 1.0 | 4.2 | 24 | 47 | 1 |
| PG-4 | 1.0 | 2.3 | — | — | 1 |
| PG-5 | 10.1 | 12.3 | 28 | 59 | 2 |

As is apparent from Table 5 the amount of cyclic compounds is significantly lower in examples PG-1 through PG-4 than in example PG-5. Moreover, the free monomer (i.e., glycerin) is lower in PG-2, PG-3 and PG-4 than in the example PG-5. PG-5 contains less amount of primary OH which demonstrates less linearity in comparison with PG-1, PG-2, PG-3 and PG-4.

### Polyglycerine Initiated Polyol Production

Polyglycerin initiated polyoxypropylene polyols were prepared by propoxylating the polyglycerine initiators, using KOH catalysts and capping them with about 16.0 wt % ethylene oxide, temperature 130° C. KOH end batch amount about 2000 ppm. Hydroxyl equivalent weights (HEW) of about 1902 were obtained simulating the VORALUX™ HF505 elsewhere described.

Table 6 summarizes the hydroxyl numbers, nominal and real functionalities for the final polyols initiated with PG-2, PG-4 and PG-5 respectively. Properties of Voralux HF-505 are also included for comparative purposes.

TABLE 6

| | Hydroxyl | Nominal | Real | Viscosity, |
|---|---|---|---|---|
| Sample | Number, mg/g | Functionality | Functionality | 25° cSt |
| PL-PG2 | 28.0 | 4.9 | 2.9 | 1430 |
| PL-PG4 | 26.8 | 6.5 | 4.2 | 1580 |
| PL-PG5 | 28.6 | 4.7 | 2.7 | 1330 |
| HF505 | 29.5 | 5.4 | 3.4 | 1500 |

### Polyurethane Examples and Comparative Examples

Flexible polyurethane foams were produced utilizing the polyols PL-PG2, PL-PG4 and PL-PG5 combined with other polyols, including SAN copolymer polyols. Comparative examples utilized Voralux HF-505 as shown and described below.

A description of the raw materials used in the examples is as follows. SPECFLEX™ NC 632 is a 1,700 equivalent weight polyoxypropylene polyoxyethylene polyol initiated with a blend of glycerol and sorbitol, available from The Dow Chemical Company. SPECFLEX™ NC700 is a grafted polyether polyol containing 40% SAN based copolymer polyol, available from The Dow Chemical Company. VORALUX™ HF505 is a sorbitol initiated polyoxypropylene polyol capped with about 16 wt % ethylene oxide having a hydroxyl equivalent weight of about 1902, and is available from The Dow Chemical Company. DEOA is dliethanolamine 99% available from Aldrich Company. DABCO 33LV is a 33 wt % solution of triethylenediamine in propylene glycol, available from Air Products and Chemicals, Inc. NIAX™ A-1 is a tertiary amine catalyst available from Momentive Performance Materials. NIAX™ A-300 is a tertiary amine catalyst available from Momentive Performance Materials. TEGOSTAB™ B8715LF is a silicon-based surfactant available from the Evonik Industries. TEGOSTAB™ B8719LF is a silicon-based surfactant available from the Evonik Industries. SPECFLEX™ TM20 is a 80% Voranate T-80 (80 wt % 2,4 TDI and 20 wt % 2,6 TDI) and 20% Voranate M-229 (a polymeric MDI) by weight blend, available from The Dow Chemical Company. VORANOL™ CP1421 is a glycerol initiated polyoxyethylene polyol having an average hydroxyl number of 32, available from The Dow Chemical Company. ORTEGOL 204 is a block stabilizer available from Evonik Industries. KOSMOS 54 is a zinc ricinoleate catalyst available from the Evonik Industries. TEGOSTAG™ B8681 is a foam stabilizer based on polysiloxane-polyether commercially available from Goldschmidt AG. VORANATE™ T80 is an 80/20 blend of the 2,4 and 2,6 TDI isomers, available from The Dow Chemical Company. ORTEGOL™ 204 is a proprietary crosslinker containing water, available from Evonik Industries.

Tables 7-9 illustrate several high resilient polyether polyol based foams including examples formed utilizing the polyglycerine initiated polyols, PL-PG's , of the present invention and comparative examples. Each of the foams of examples 1 through 5 was molded foams obtained from hand mixed runs.

TABLE 7

| | Comp. Ex. 1 | Ex. 1 | Ex. 2 | Ex. 3 | Ex. 4 | Ex. 5 |
|---|---|---|---|---|---|---|
| Specflex NC632 | | | 10 | | | 10 |
| Specflex NC700 | 30 | 30 | 30 | 30 | 30 | 30 |
| Voralux HF505 | 70 | | | | | |
| PL-PG-5 | | 70 | 60 | | | |
| PL-PG-2 | | | | 70 | | 60 |
| PL-PG-4 | | | | | 70 | |
| Water | 3.0 | 3.0 | 3.0 | 3.0 | 3.0 | 3.0 |
| DEOA 99% | 0.7 | 0.7 | 0.7 | 0.7 | 0.7 | 0.7 |
| Dabco 33LV | 0.3 | 0.3 | 0.3 | 0.3 | 0.3 | 0.3 |
| Niax A-1 | 0.05 | 0.05 | 0.05 | 0.05 | 0.05 | 0.05 |
| Niax A-300 | 0.1 | 0.1 | 0.1 | 0.1 | 0.1 | 0.1 |
| Tegostab B8715LF | 0.5 | 0.5 | 0.5 | 0.5 | 0.5 | 0.5 |
| Tegostab B8719LF | 0.2 | 0.2 | 0.2 | 0.2 | 0.2 | 0.2 |
| Specflex TM20 Index | 100 | 100 | 100 | 100 | 100 | 100 |
| Mold exit time (sec) | NA | 36 | 31 | 35 | 33 | 33 |
| Demolding Time (min) | 6 | 6 | 6 | 6 | 6 | 6 |
| Part weight (g) | 455 | 453 | 447 | 454 | 467 | 453 |
| Core dens. | 47.1 | 47.7 | 45 | 47.1 | 47.3 | 45.9 |
| 50% CFD (Kpa) | 7.3 | 6.1 | 5.8 | 6.2 | 7.4 | 6.0 |
| % hysteresis | 78.2 | 78.0 | 80.2 | 79.6 | 79.1 | 80.3 |
| Sag factor | 2.7 | 2.8 | 2.7 | 2.8 | 2.6 | 2.7 |
| Airflow (cfm) | 3.6 | 4.3 | 4.1 | 4.3 | 3.5 | 3.6 |
| Resiliency (%) | 65 | 63 | 70 | 69 | 66 | 69 |
| 70% Wet CS skin | 38.7 | 40.1 | 38.9 | 38.9 | 33.6 | 36.3 |
| 50% CS (CD) | 7.5 | 8.1 | 6.0 | 8.4 | 7.6 | 6.7 |
| 75% CS (CD) | 7.1 | 6.9 | 5.6 | 6.7 | 6.0 | 5.9 |
| Tensile Strength (Kpa) | 149 | 151 | 138 | 148 | 138 | 147 |
| Elongation (%) | 96 | 107 | 99 | 104 | 90 | 108 |
| Tear Strength (N/m) | 254 | 285 | 286 | 278 | 227 | 278 |

Table 7 illustrates that foams made from polyglycerine initiated polyols PL-PG 2, PL-PG-4 and PL-PG5 have comparable or higher TTE values than the comparative foams based on Voralux* HF 505, e.g., Comparative Ex. 1. Of importance are the improved foam Tear Strength properties exhibiting less tearing when making automotive seats. In addition, increased foam airflow values comfirm the good processing of these molded pads.

The foams illustrated in Tables 8 and 9 are free rise foams produced by hand mixing. Examples 6 to 15 illustrate that foams made from polyglycerine polyols are at least equal and in many cases superior in TTEs in comparison to the comparative example foams produced using Voralux HF 505, e.g., Comparative Example 2, at equivalent foam hardness (50% CFD values) and have improved foam resiliency. Thus, a fine tuning of the polyglycerine initiator structure can be applied to optimize and improve foam properties, including those properties useful in the handling and transportation of cubic meter sized slabstock foam wherein costly damage from tearing is preferably avoided and/or minimized.

TABLE 8

| | Comp. Ex. 2 | Ex. 6 | Ex. 7 | Ex. 8 | Ex. 9 | Ex. 10 |
|---|---|---|---|---|---|---|
| Specflex NC632 | | | 10 | | | 10 |
| Voralux HL400 | 35 | 35 | 35 | 35 | 35 | 35 |
| Voralux HF505 | 65 | | | | | |
| PL-PG-5 | | 65 | 55 | | | |
| PL-PG-2 | | | | 65 | | 55 |
| PL-PG-4 | | | | | 65 | |
| Voranol CP1421 | 0.5 | 0.5 | 0.5 | 0.5 | 0.5 | 0.5 |
| Ortegol 204 | 1.8 | 1.8 | 1.8 | 1.8 | 1.8 | 1.8 |
| Water | 2.1 | 2.1 | 2.1 | 2.1 | 2.1 | 2.1 |
| DEOA 99% | 0.6 | 0.6 | 0.6 | 0.6 | 0.6 | 0.6 |
| Dabco 33LV | 0.08 | 0.08 | 0.08 | 0.08 | 0.08 | 0.08 |
| Niax A-1 | 0.03 | 0.03 | 0.03 | 0.03 | 0.03 | 0.03 |
| Kosmos 54 | 0.5 | 0.5 | 0.5 | 0.5 | 0.5 | 0.5 |
| Tegostab B8681 | 0.5 | 0.5 | 0.5 | 0.5 | 0.5 | 0.5 |
| Stannous Octoate | 0.1 | 0.1 | 0.1 | 0.1 | 0.1 | 0.1 |
| Voranate T80 Index | 105 | 105 | 105 | 105 | 105 | 105 |
| Core dens. | 35.4 | 36.1 | 36.1 | 36.1 | 36.8 | 36.1 |
| 50% CFD (KPa) | 4.5 | 4.5 | 4.5 | 4.6 | 4.9 | 4.4 |
| % Hysteresis | 68.2 | 69.9 | 69.8 | 69.5 | 69.3 | 70 |
| Sag factor | 2.8 | 2.8 | 2.8 | 2.8 | 2.8 | 2.8 |
| Airflow (cfm) | 0.9 | 0.9 | 0.9 | 0.5 | 0.9 | 0.9 |
| Resiliency (%) | 48 | 49 | 49 | 49 | 47 | 50 |
| 50% CS (CD) | 8.7 | 9.6 | 9.6 | 9.4 | 8.9 | 10.1 |
| 75% CS (CD) | 6.9 | 8.4 | 7.6 | 7.4 | 7.6 | 7.9 |
| Tensile Strength (Kpa) | 99 | 114 | 119 | 99 | 94 | 115 |
| Elongation (%) | 116 | 131 | 138 | 120 | 112 | 136 |
| Tear Strength (N/m) | 266 | 310 | 293 | 297 | 262 | 299 |

TABLE 9

| | Comp. | | | | | |
|---|---|---|---|---|---|---|
| | Ex. 3 | Ex. 11 | Ex. 12 | Ex. 13 | Ex. 14 | Ex. 15 |
| Specflex | | | 10 | | | 10 |
| NC632 | | | | | | |
| Voralux HL400 | 50 | 50 | 40 | 50 | 50 | 40 |
| Voralux HF505 | 50 | | | | | |
| PL-PG-5 | | 50 | 50 | | | |
| PL-PG-2 | | | | 50 | | 50 |
| PL-PG-4 | | | | | 50 | |
| Voranol | 0.5 | 0.5 | 0.5 | 0.5 | 0.5 | 0.5 |
| CP1421 | | | | | | |
| Ortegol 204 | 1.8 | 1.8 | 1.8 | 1.8 | 1.8 | 1.8 |
| Water | 2.1 | 2.1 | 2.1 | 2.1 | 2.1 | 2.1 |
| DEOA 99% | 0.6 | 0.6 | 0.6 | 0.6 | 0.6 | 0.6 |
| Dabco 33LV | 0.08 | 0.08 | 0.08 | 0.08 | 0.08 | 0.08 |
| Niax A-1 | 0.03 | 0.03 | 0.03 | 0.03 | 0.03 | 0.03 |
| Kosmos 54 | 0.5 | 0.5 | 0.5 | 0.5 | 0.5 | 0.5 |
| Stannous | 0.5 | 0.5 | 0.5 | 0.5 | 0.5 | 0.5 |
| Octoate | | | | | | |
| Tegostab | 0.1 | 0.1 | 0.1 | 0.1 | 0.1 | 0.1 |
| B8681 | | | | | | |
| Voranate T80 | 110 | 110 | 110 | 110 | 110 | 110 |
| Index | | | | | | |
| Core dens. | 33.9 | 35.3 | 35.3 | 34.8 | 35.4 | 35.6 |
| 50% CFD | 5.9 | 5.9 | 5.1 | 5.9 | 6.1 | 5.2 |
| (Kpa) | | | | | | |
| % hysteresis | 62.2 | 64 | 67.4 | 63.3 | 64.31 | 70 |
| Sag factor | 2.9 | 2.8 | 2.8 | 2.8 | 2.8 | 2.8 |
| Airflow (cfm) | 1.6 | 1.3 | 1.3 | 1.5 | 1.2 | 1.3 |
| Resiliency (%) | 42 | 45 | 49 | 44 | 44 | 48 |
| 50% CS (CD) | 11.8 | 10.9 | 10.2 | 12.1 | 11.6 | 10.8 |
| 75% CS (CD) | 9.8 | 9.5 | 8.2 | 9.2 | 9.8 | 8.7 |
| Tensile | 130 | 142 | 124 | 134 | 132 | 114 |
| Strength (Kpa) | | | | | | |
| Elongation (%) | 115 | 125 | 125 | 118 | 116 | 119 |
| Tear Strength | 341 | 369 | 320 | 388 | 356 | 343 |
| (N/m) | | | | | | |

1.-13. (canceled)

14. A polyglycerine alkoxylated polyether polyol, comprising:
a reaction product of a base catalyzed addition of an alkylene oxide onto a polyglycerine initiator prepared by glycidol polymerization of glycerin, the reaction product having a hydroxyl equivalent weight between 800 and 4,000, and a final functionality between 1.5 and 6, the polyglycerine initiator having a range of functionalities varying between 2 and 16.

15. The polyglycerine alkoxylated polyether polyol of claim 14, wherein the polyglycerine initiator has from 0.9 to 1.5 percent by weight of cyclic compounds as determined by high performance liquid chromatography with refractive index detection (HPLC-RI).

16. The polyglycerine alkoxylated polyether polyol of claim 15, wherein the alkylene oxide is propylene oxide, ethylene oxide, or a combination of propylene oxide and ethylene oxide.

17. The polyglycerine alkoxylated polyether polyol of claim 14, wherein the polyglycerine alkoxylated polyether polyol has an unsaturation between 0.02 meq/g and 1.0 meq/g.

18. The polyglycerine alkoxylated polyether polyol of claim 14, wherein the glycidol polymerization of glycerin is performed at temperatures less than 130° C.

19. The polyglycerine alkoxylated polyether polyol of claim 14, wherein the base is potassium hydroxide.

18. The polyglycerine alkoxylated polyether polyol of claim 14, wherein the reaction product is a polyglycerine propoxylated polyether polyol end-capped with ethylene oxide.

19. A process for producing the polyglycerine alkoxylated polyether polyol of claim 14, wherein:
the polyglycerine initiator is prepared by the glycidol polymerization of glycerin, and then, the base catalyzed addition of the alkylene oxide onto the polyglycerine initiator is performed.

20. The process for producing the polyglycerine alkoxylated polyether polyol of claim 19, wherein the glycidol polymerization of glycerin is performed at temperatures less than 130° C.

21. A composition for producing a polyurethane polymer, comprising:
a polyol including between 5 wt % and 100 wt % of the polyglycerine alkoxylated polyether polyol of claim 1; and
at least one organic isocyanate; and
an amine and/or metal salt catalyst.

22. A composition for producing polyurethane flexible foam, comprising:
a polyol including between 5 wt % and 100 wt % of the polyglycerine alkoxylated polyether polyol of claim 14; and
at least one organic isocyanate; and
an amine and/or metal salt catalyst.
